(19) United States
(12) Patent Application Publication
(10) Pub. No.: US 2024/0382041 A1
(43) Pub. Date: Nov. 21, 2024

(54) ROBOTIC SYSTEM FOR COOKING FOOD PRODUCTS AND METHOD FOR USING THE SAME

(71) Applicants: Charles S. Reid, Holland, MI (US); Brian Rudesill, Hudson, WI (US)

(72) Inventors: Charles S. Reid, Holland, MI (US); Brian Rudesill, Hudson, WI (US)

(21) Appl. No.: 18/665,679

(22) Filed: May 16, 2024

Related U.S. Application Data
(60) Provisional application No. 63/467,641, filed on May 19, 2023.

(51) Int. Cl. A47J 37/12; B25J 11/00

(52) U.S. Cl. CPC A47J 37/1219; A47J 37/1228; A47J 37/1266; A47J 37/129; B25J 11/0045

(57) ABSTRACT

A robotic system for cooking food products, including: (a) a robotic arm, wherein the robotic arm includes a pair of opposing gripping members, and wherein the robotic arm is horizontally displaceable within a first plane, vertically displaceable within a second plane, and pivotally displaceable about a first axis; (b) a cooking reservoir basin for containing oil, wherein the cooking reservoir basin includes a basket flipping plate, and one or more basket holders; (c) a cooked food products basin for containing cooked food products; (d) means for heating oil in the cooking reservoir basin; (e) an optional hopper for supplying food products; and (f) a control panel for controlling/directing the robotic arm.

### CROSS-REFERENCE TO RELATED APPLICATIONS

This application claims the benefit of U.S. Provisional Patent Application Ser. No. 63/467,641, entitled “ROBOTIC SYSTEM FOR COOKING FOOD PRODUCTS,” filed May 19, 2023-all of which is hereby incorporated herein by reference in its entirety, including all references cited therein.

### COPYRIGHT NOTICE

This application includes material that is subject to copyright protection. The copyright owner has no objection to the facsimile reproduction by anyone of the patent disclosure, as it appears in the United States Patent and Trademark Office files or records, but otherwise reserves all copyright rights whatsoever.

### STATEMENT REGARDING FEDERALLY SPONSORED RESEARCH OR DEVELOPMENT

Not applicable.

### REFERENCE TO A SEQUENCE LISTING

Not applicable.

### BACKGROUND OF THE INVENTION

### 1. Field of the Invention

The present invention relates in general to robotic systems, and, more particularly, to simplified, durable, and cost-effective robotic systems for cooking/deep frying food products (e.g., French fries, onion rings, chips, chicken nuggets, fish filets, chicken patties, corn dogs, donuts, etcetera). The present invention is also directed to methods for cooking food products using robotic systems.

### 2. Background Art

Complex and expensive robotic systems have been known in the art for years and are the subject of a plurality of patents and publications, including: U.S. Pat. No. 11,192,258 entitled “Robotic Kitchen Assistant for Frying Including Agitator Assembly for Shaking Utensil,” U.S. Pat. No. 10,154,756 entitled “Automated Kitchen Workspace with Robot,” U.S. Pat. No. 8,276,506 entitled “Cooking Assistance Robot and Cooking Assistance Method,” U.S. Pat. No. 5,386,762 entitled “Robotic Chef,” U.S. Pat. No. 4,922,435 entitled “Food Preparation Robot,” U.S. Pat. No. 4,919,950 entitled “Computer Controlled, Fully Automatic, Short-Order Wok Cooking System for Preparing Stir-Fried Chinese Food,” U.S. Pat. No. 4,545,723 entitled “Apparatus for Adapting an End Effector Device Remotely Controlled Manipulator Arm,” United States Patent Application Publication Number 2018/0043526 entitled “Methods and Systems for Food Preparation in a Robotic Cooking Kitchen,” United States Patent Application Publication Number 2004/0154474 entitled “Food Cooker,” and International Publication Number WO 2017/114014 entitled “Cooking Robot”-all of which are hereby incorporated herein by reference in their entirety including all references cited therein.

U.S. Pat. No. 11,192,258 appears to disclose a robotic kitchen assistant for frying that includes a robotic arm, a fryer basket, and a robotic arm adapter assembly allowing the robotic arm to pick up and manipulate the fryer basket. The robotic arm adapter includes opposing gripping members to engage the fryer basket. A utensil adapter assembly is mounted to the handle of the fryer basket, and the opposing gripper members are actuated to capture a three-dimensional (3D) feature of the utensil adapter assembly. The robotic arm adapter assembly can include an agitator mechanism to shake the fryer basket or another utensil as desired.

U.S. Pat. No. 10,154,756 appears to disclose a method of preparing meals in a computerized kitchen workspace. The computerized kitchen workspace includes one or more robots for preparing and cooking food in the kitchen workspace. Kitchen appliances may be automatically controlled according to a recipe. The one or more robots may access kitchen items necessary for meal preparation by rotating automated shelves. The meal may then be automatically prepared by the one or more robots. Automated storage shelves may be provided with electrical power for powering kitchen appliances found on the shelves.

U.S. Pat. No. 8,276,506 appears to disclose a cooking assistance robot that is capable of efficient mixing using ingredients that are unlikely to be evenly heated. The cooking assistance robot performs cooking by physically moving ingredients in a cooking container selects a mixing direction for leveling a mountain and performs a mountain leveling operation in the selected mixing direction in a presence of a mountain of a specified height or higher in the cooking container.

U.S. Pat. No. 5,386,762 appears to disclose an automated food preparation system having a continuously rotatable annular segmented cooking area, a food feeding system, and an industrial robot, all of which are controlled by a pre-programmed programmable controller, wherein an operator provides input to the programmable controller selecting each food item to be cooked and the programmable controller commands the industrial robot to select the food item, place the food item on the cooking area for cooking, turn the food item at the proper time, and remove the food item from the cooking area.

U.S. Pat. No. 4,922,435 appears to disclose a fully automated robotized system and method for cooking food products. The system and method claims to be especially useful for use in a quick service or fast food restaurant and, in one embodiment, is capable of cooking, on a fully automated basis, French fries, chicken nuggets, fish filets and chicken patties. In one embodiment, the system includes a robot, a bulk uncooked food dispensing station, a cooking station and a cooked food storage station. The system can be controlled by a computer operating and control station that controls and directs the robot to obtain bulk food from the dispensing station, place it in cooking position at the cooking station and when cooked, remove the food and deliver it to the storage station, at a rate required to fill anticipated customer orders.

U.S. Pat. No. 4,919,950 appears to disclose a computer controlled, fully automatic wok cooking system that prepares stir-fried, Chinese dishes according to arbitrarily selected customer orders entered at a point-of-sale computer. The computer integrates the operation of the conveyer, cooking, dispensing, and point of sale entry devices according the order, menu and ingredients, A conveyor belt including a plurality of woks draws the woks through a plurality of cooking stations. Each station is provided with a burner or heating element and a dispensing station controlled by the computer according to the customer entered order. Oil or condiments are added at a first station by a corresponding plurality of dispensers and at subsequent cooking stations the food ingredients are either stirred or additional spices, food ingredients and condiments added by corresponding dispensers. At the last cooking station, additional food ingredients, such a vegetables, nuts or other ingredients requiring shorter cooking times, are added and cooking is completed. The completed short order stir-fried dish is then delivered to a serving container at a delivery station. The emptied wok is advanced by the conveyor system through a plurality of cleaning stations, where the wok is inverted, washed, scoured, rinsed and dried. The cleaned and dried wok is then returned by the conveyor system to the initial cooking station to begin the cooking process again according to the then appropriate customer order.

U.S. Pat. No. 4,545,723 appears to disclose an apparatus for adapting a general-purpose end effector device to a special purpose end effector which includes an adapter bracket assembly which provides a mechanical and electrical interface between the end effector devices. The adapter bracket assembly includes an adapter connector post which interlocks with a diamond-shaped gripping channel formed in closed jaws and of the general-purpose end effector. The angularly intersecting surfaces of the connector post and gripping channel prevent any relative movement therebetween. Containment webs constrain the outer finger plates of the general-purpose jaws to prevent pitch motion. Electrical interface is provided by conical, self-aligning electrical connector components carried by respective ones of said end effectors.

United States Patent Application Publication Number 2018/0043526 appears to disclose methods, computer program products, and computer systems for instructing a robot to prepare a food dish by replacing the human chef's movements and actions. Monitoring a human chef is carried out in an instrumented application-specific setting, a standardized robotic kitchen in this instance, and involves using sensors and computers to watch, monitor, record and interpret the motions and actions of the human chef, in order to develop a robot-executable set of commands robust to variations and changes in the environment, capable of allowing a robotic or automated system in a robotic kitchen to prepare the same dish to the standards and quality as the dish prepared by the human chef.

United States Patent Application Publication Number 2004/0154474 appears to disclose a food cooker, in particular a deep fryer, that comprises a vessel in which a cooking medium is heated and a basket for supporting food to be cooked. The basket is adapted to move between a first position in which the food is immersed in the cooking medium and a second position in which the food is immersed from the cooking medium. An apparatus is provided for vibrating the basket in the second position to assist in removing excess cooking medium from the food.

International Publication Number WO 2017/114014 appears to disclose a cooking robot, that comprises a machine body, a charging mechanism, a feeding mechanism, a control system, a cooking mechanism and a dish collecting mechanism, wherein the control system is connected with the charging mechanism, the feeding mechanism, the cooking mechanism and the dish collecting mechanism respectively, and controls the operation of each of the mechanisms. The cooking robot utilizes a customized device for containing disposable dish raw materials, and all dish raw materials are independently packaged in a factory according to a recipe; and meanwhile, the whole cooking process is controlled through an automatic control system so that manpower and material resources are saved.

While the above-identified patents and publications do appear to disclose various complex, expensive, and maintenance intensive robotic systems for cooking food products, their configurations remain non-desirous and/or problematic inasmuch as, among other things, none of the above-identified robotic systems are simple, durable and cost-effectively cook/deep fry food products.

These and other objects of the present invention will become apparent in light of the present specification, claims, and drawings.

### SUMMARY OF THE INVENTION

The following presents a simplified summary in order to provide a basic understanding of some aspects of the claimed subject matter. This summary is not an extensive overview, and is not intended to identify key/critical elements or to delineate the scope of the claimed subject matter. Its purpose is to present some concepts in a simplified form as a prelude to the more detailed description that is presented later.

The present invention is directed to a robotic system for cooking food products, comprising, consisting essentially of, and/or consisting of: (a) a robotic arm, wherein the robotic arm includes a pair of opposing gripping members, and wherein the robotic arm is horizontally displaceable within a first plane, vertically displaceable within a second plane, and pivotally displaceable about a first axis; and (b) a control panel for controlling/directing the robotic arm.

The present invention is further directed to a robotic system for cooking food products, comprising, consisting essentially of, and/or consisting of: (a) a robotic arm, wherein the robotic arm includes a pair of opposing gripping members, and wherein the robotic arm is horizontally displaceable within a first plane, vertically displaceable within a second plane, and pivotally displaceable about a first axis; (b) a cooking reservoir basin for containing oil, wherein the cooking reservoir basin includes a basket flipping plate, and one or more basket holders; (c) a cooked food products basin for containing cooked food products; (d) means for heating oil in the cooking reservoir basin; (e) an optional hopper for supplying food products; and (f) a control panel for controlling/directing the robotic arm.

The present invention is also directed to a method for cooking food products using a robotic system, comprising, consisting essentially of, and/or consisting of the steps of: (a) providing a robotic system comprising: (1) a robotic arm, wherein the robotic arm includes a pair of opposing gripping members, and wherein the robotic arm is horizontally displaceable within a first plane, vertically displaceable within a second plane, and pivotally displaceable about a first axis; (2) a cooking reservoir basin for containing oil, wherein the cooking reservoir basin includes a basket flipping plate, and one or more basket holders; and (3) a cooked food products basin for containing cooked food products; (b) providing a food basket; (c) filling the food basket with a food product manually by a human or robotically by a robotic system; (d) positioning the food basket with the food product into the cooking reservoir basin for a period of time; (e) optionally positioning the food basket above the cooking reservoir basin and vertically shaking the food basket; and (f) transferring the cooked food product from the cooking reservoir basin to the cooked food products basin via pivoting the robotic arm upon contact with the basket flipping plate.

### BRIEF DESCRIPTION OF THE DRAWINGS

Certain embodiments of the present invention are illustrated by the accompanying figures. It will be understood that the figures are not necessarily to scale and that details not necessary for an understanding of the invention or that render other details difficult to perceive may be omitted.

It will be further understood that the invention is not necessarily limited to the particular embodiments illustrated herein.

The invention will now be described with reference to the drawings wherein:

FIGS. 1-9 of the drawings are views of a first embodiment of a robotic system of the present invention shown in a plurality of positions/configurations;

FIGS. 10-11 of the drawings are views of a second embodiment of a robotic system of the present invention shown in a plurality of positions/configurations; and

FIG. 12 of the drawings is a flow chart showing a method for cooking food products using the robotic systems of the present invention.

### DETAILED DESCRIPTION OF THE INVENTION

While this invention is susceptible of embodiment in many different forms and applications, there are shown in the drawings and described herein in detail several specific embodiments with the understanding that the present disclosure is to be considered as an exemplification of the principles of the invention and is not intended to limit the invention to the embodiments illustrated.

It will be understood that like or analogous elements and/or components, referred to herein, may be identified throughout the drawings by like reference characters. In addition, it will be understood that the drawings are merely schematic representations of one or more embodiments of the invention, and some of the components may have been distorted from their actual scale for purposes of pictorial clarity.

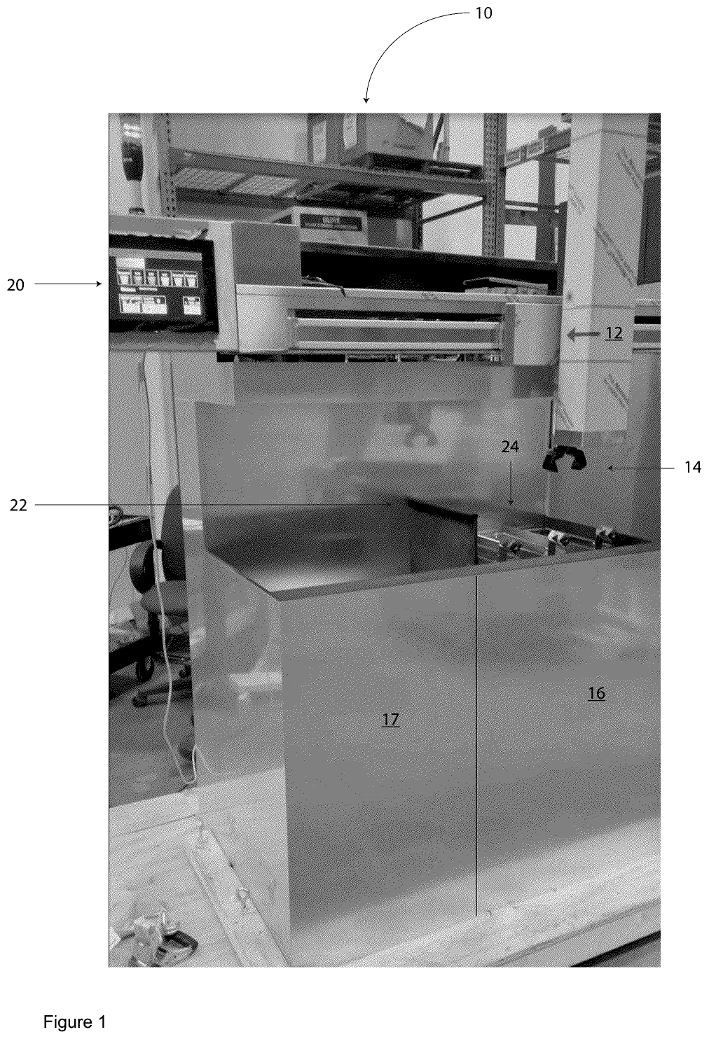

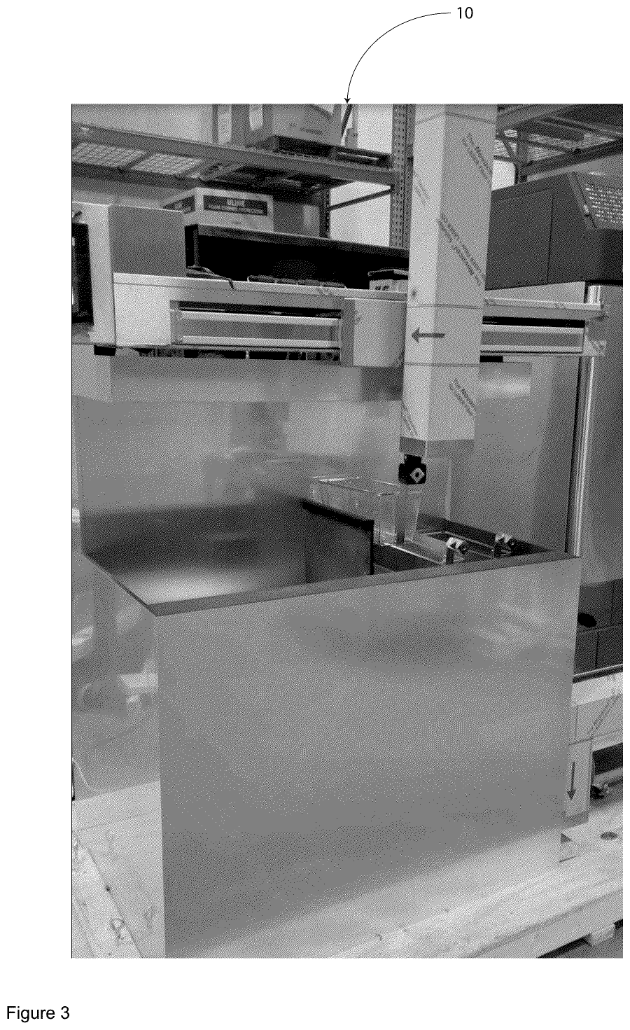

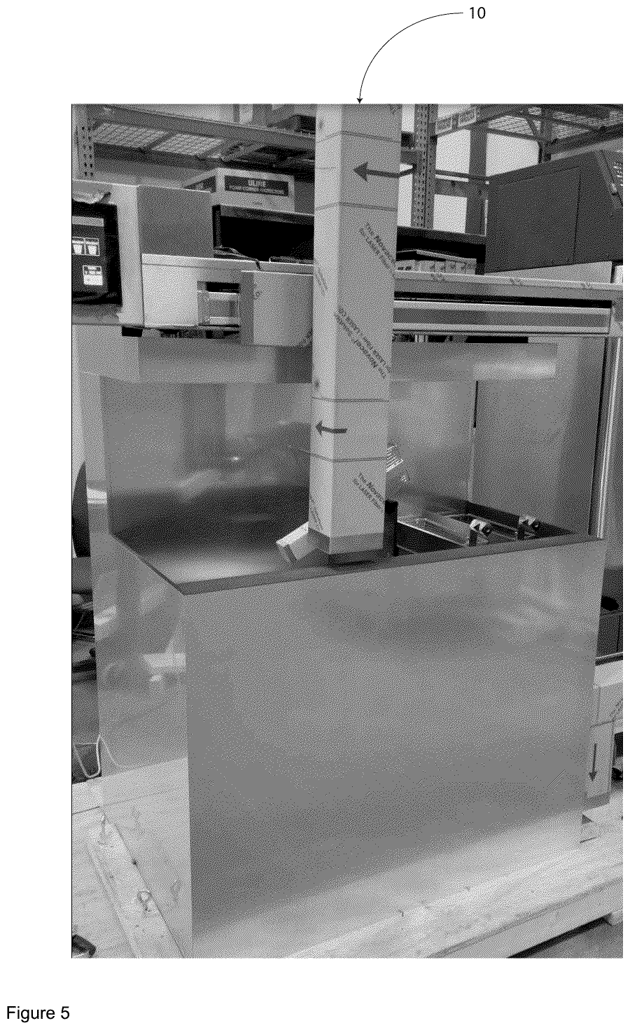

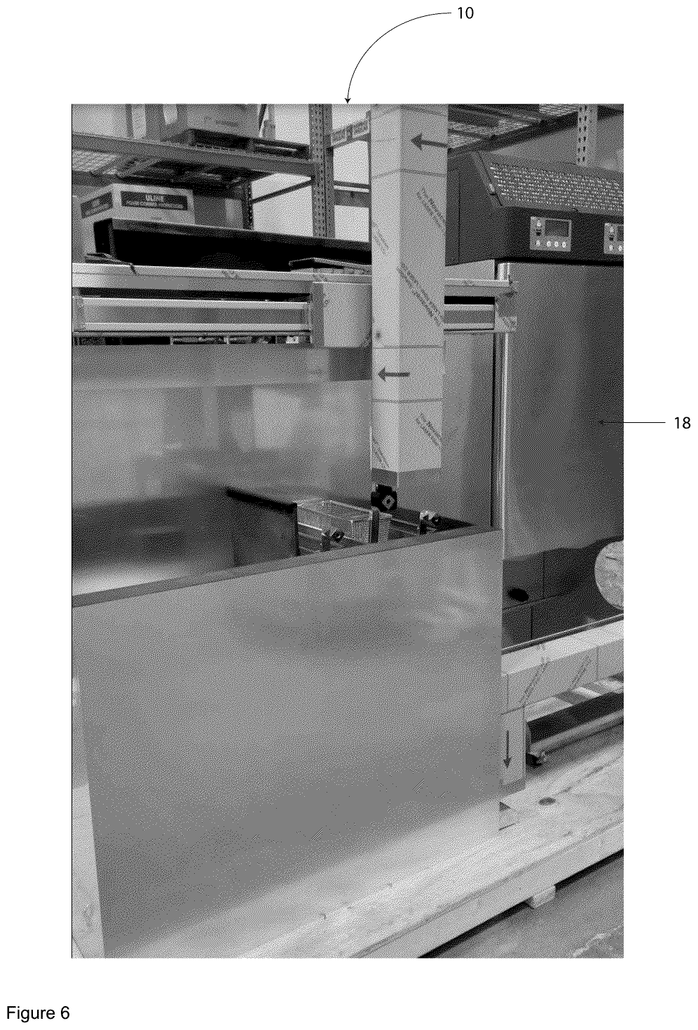

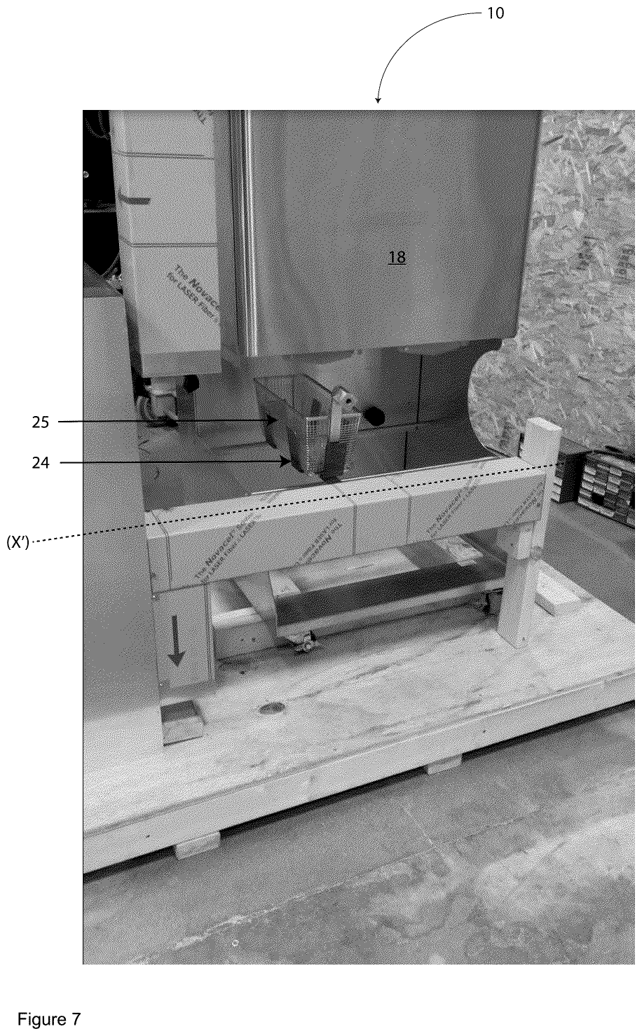

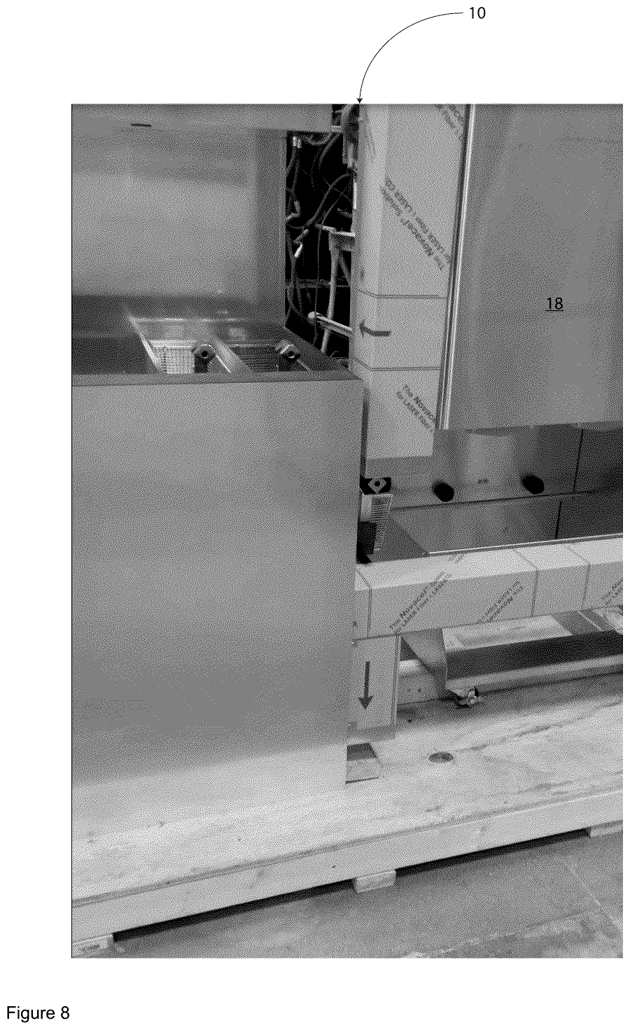

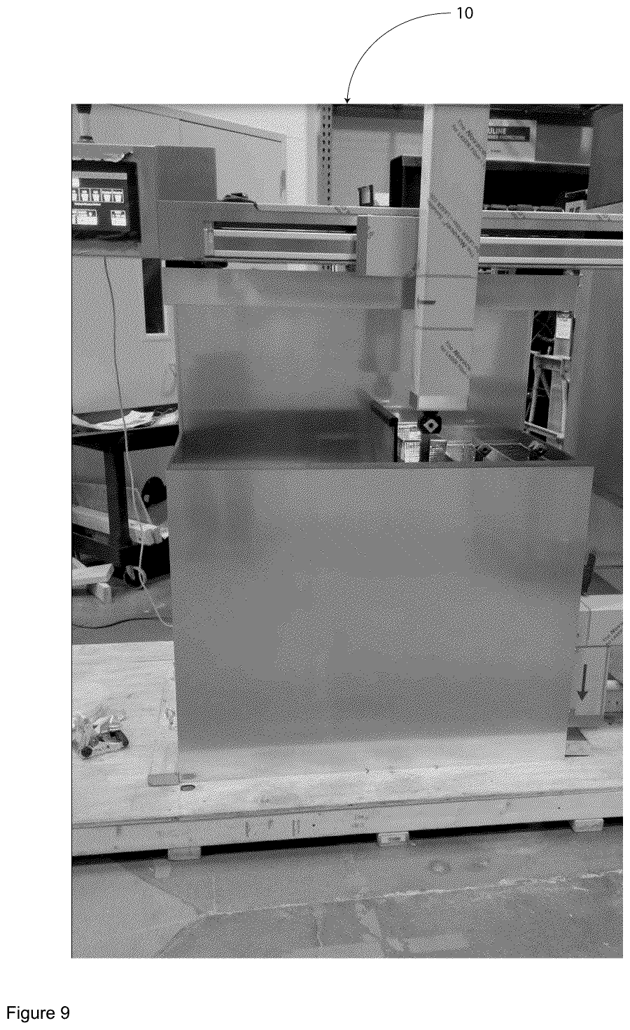

Referring now to the drawings, and to FIGS. 1-9 in particular, a first embodiment of robotic system 10, for cooking food products, is shown as generally comprising robotic arm 12 having opposing gripping members 14, cooking reservoir basin 16, cooked food products basin 17, optional hopper 18 for supplying food products, and control panel 20 for controlling/directing the robotic arm.

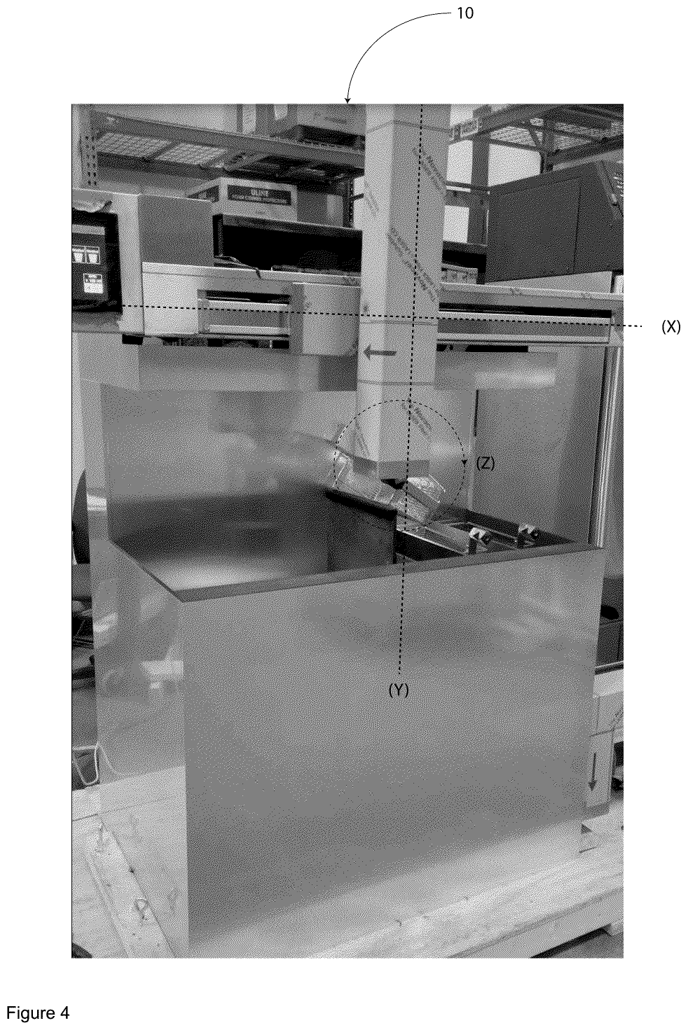

Robotic arm 12 is horizontally displaceable within a first plane (X), vertically displaceable within a second plane (Y), and pivotally displaceable about a first axis (Z) (See FIG. 4).

Cooking reservoir basin 16 preferably contains cooking oil and includes basket flipping plate 22 and one or more basket holders 24. The cooking oil is preferably heated via a conventional electric or gas heating element that is in communication with control panel 20.

Optional hopper 18 contains food product (e.g., French fries, onion rings, chips, chicken nuggets, fish filets, chicken patties, corn dogs, donuts, etcetera) which supplies the baskets with food for an extended period of time (e.g., 1 hour, 2 hours, 3 hours, 4 hours, 5 hours, 6 hours, 7 hours, 8 hours, a shift, a day, etcetera). Hopper 18 includes basket holder 24 that is horizontally displaceable within plane (X′).

Control panel 20 is used for controlling/directing the robotic arm. Preferably, control panel 20 is operated via a graphical user interface (GUI) and in cooperation with a controller (printed circuit board, CPU, etcetera) enables a plurality of functionality, including, but not limited to: (1) filling baskets with food products, (2) moving baskets to cooking reservoir, (3) cooking food for a predetermined amount of time, (4) removing the food products from the cooking oil, (5) performing a shaking function (up/down vertical displacement), (6) performing a food dumping function in cooperation with the basket flipping plate, and (7) returning the empty basket to a predetermined location (e.g., hopper for filling, basket holder, reservoir, etcetera).

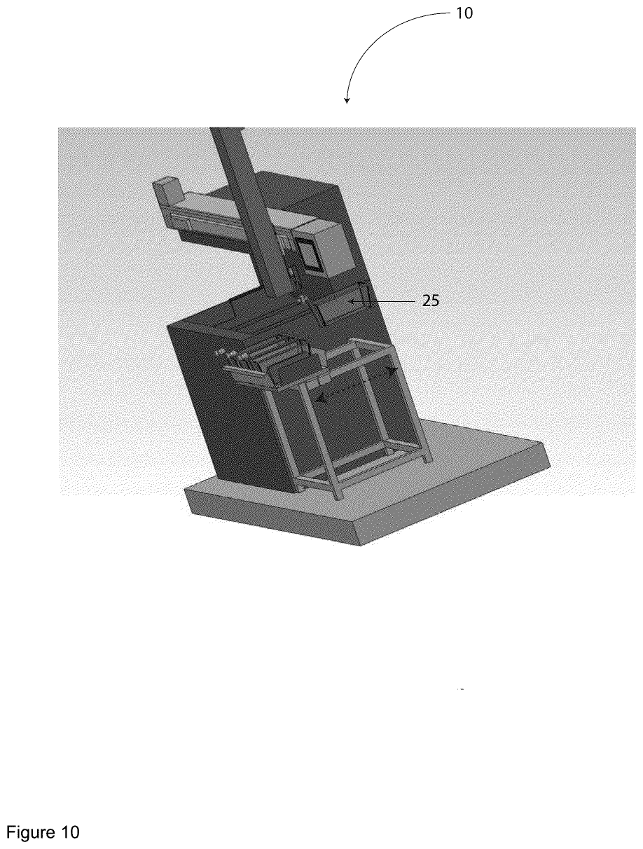

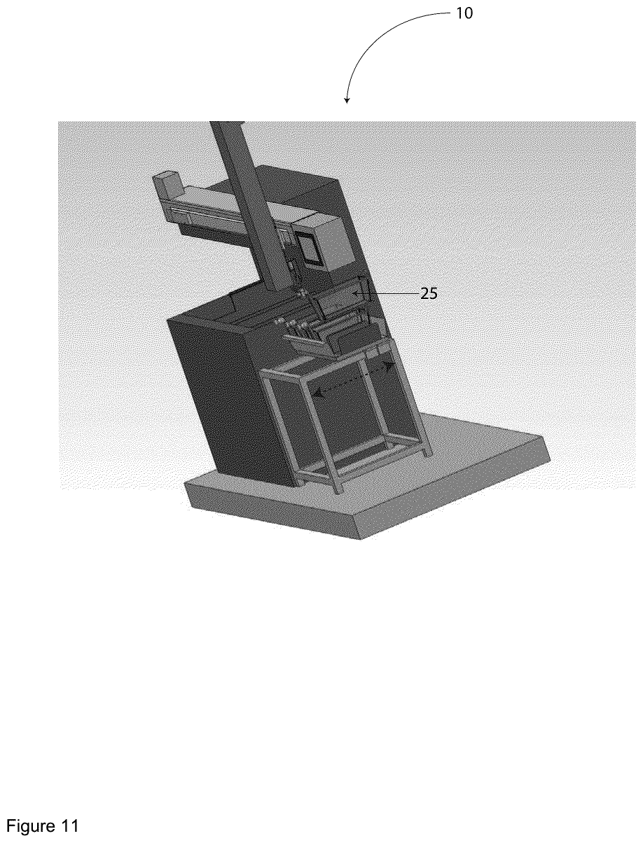

Referring now to FIGS. 10-11, a second embodiment of a robotic system 10 is shown devoid of optional hopper 18. In this embodiment, a human/worker fills one or more food baskets 25, positioned within a basket holder, with a food product (e.g., fries) and then slides the food baskets to the back/rear so that robotic arm 12 can carry out cooking the food products.

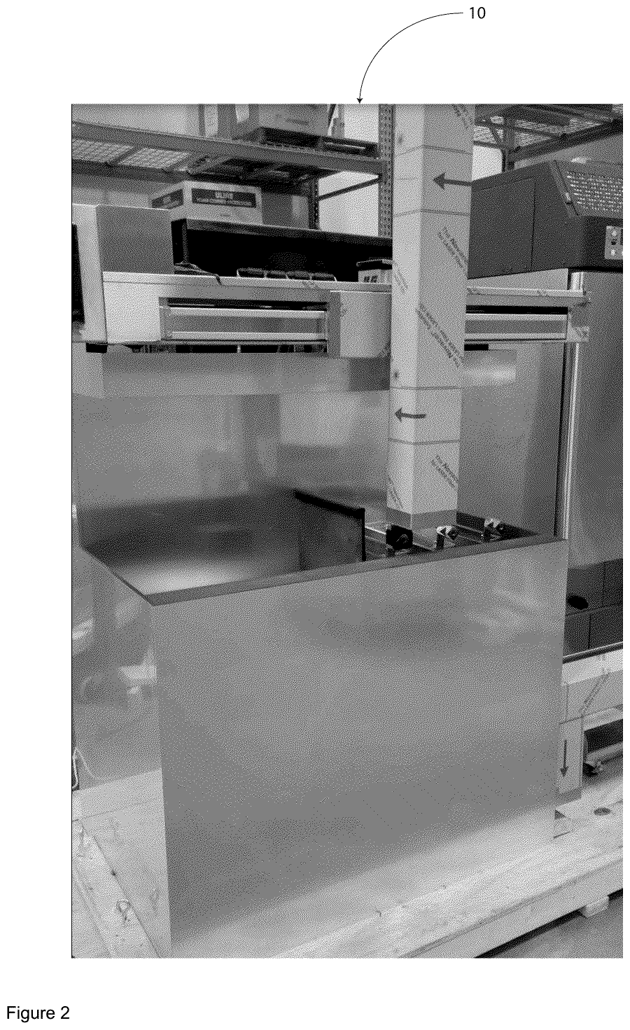

Referring now to FIGS. 2-6, the present invention is directed to a method/process for dumping food products. FIGS. 2-6 are sequential in nature and show step-by-step how the system dumps food products in a simple and efficient manner with just one robotic arm that pivots when the food basket held by the robotic arm contacts the basket flipping plate. The basket flipping plate is divided and/or is positioned between the cooking reservoir basin and the storage/cooked food products basin. Additional details are shown in the collective drawings.

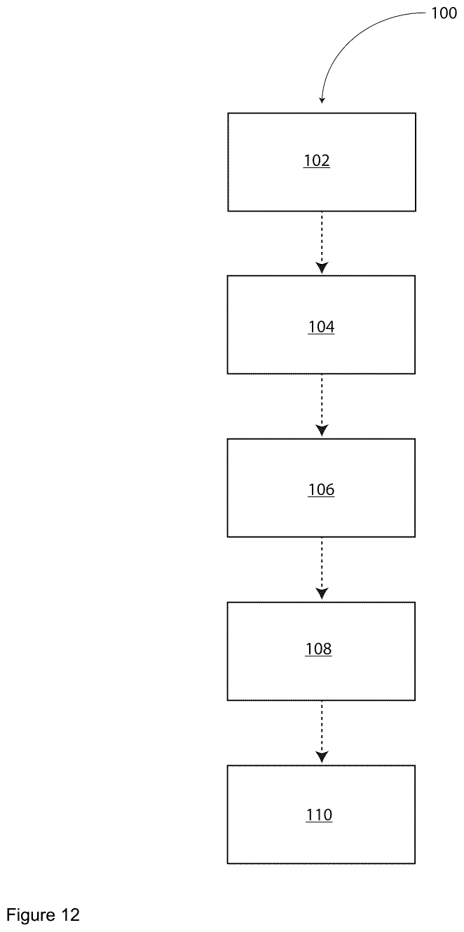

As is shown in FIG. 12, the present invention is also directed to method 100 for cooking food products using robotic system 10, comprising the steps of: providing robotic system 10 comprising: a robotic arm, wherein the robotic arm includes a pair of opposing gripping members, and wherein the robotic arm is horizontally displaceable within a first plane, vertically displaceable within a second plane, and pivotally displaceable about a first axis; a cooking reservoir basin for containing oil, wherein the cooking reservoir basin includes a basket flipping plate, and one or more basket holders; and a cooked food products basin for containing cooked food products; providing a food basket (102); filling the food basket with a food product manually by a human or robotically by a robotic system (104); positioning the food basket with the food product into the cooking reservoir basin for a period of time (106); optionally positioning the food basket above the cooking reservoir basin and vertically shaking the food basket (108); and transferring the cooked food product from the cooking reservoir basin to the cooked food products basin via pivoting the robotic arm upon contact with the basket flipping plate (110).

The foregoing description merely explains and illustrates the invention and the invention is not limited thereto except insofar as the appended claims are so limited, as those skilled in the art who have the disclosure before them will be able to make modifications without departing from the scope of the invention.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etcetera shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etcetera. As a non-limiting example, each range discussed herein can be readily broken down into a lower third, middle third and upper third, etcetera. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed and desired to be secured by Letters Patent of the United States is:

1. A robotic system for cooking food products, comprising:
a robotic arm, wherein the robotic arm includes a pair of opposing gripping members, and wherein the robotic arm is horizontally displaceable within a first plane, vertically displaceable within a second plane, and pivotally displaceable about a first axis; and
a control panel for controlling/directing the robotic arm.

2. A robotic system for cooking food products, comprising:
a robotic arm, wherein the robotic arm includes a pair of opposing gripping members, and wherein the robotic arm is horizontally displaceable within a first plane, vertically displaceable within a second plane, and pivotally displaceable about a first axis;
a cooking reservoir basin for containing oil, wherein the cooking reservoir basin includes a basket flipping plate, and one or more basket holders;
a cooked food products basin for containing cooked food products;
means for heating oil in the cooking reservoir basin;
an optional hopper for supplying food products; and
a control panel for controlling/directing the robotic arm.

3. A method for cooking food products using a robotic system, comprising the steps of:
providing a robotic system comprising:
a robotic arm, wherein the robotic arm includes a pair of opposing gripping members, and wherein the robotic arm is horizontally displaceable within a first plane, vertically displaceable within a second plane, and pivotally displaceable about a first axis;
a cooking reservoir basin for containing oil, wherein the cooking reservoir basin includes a basket flipping plate, and one or more basket holders; and
a cooked food products basin for containing cooked food products;
providing a food basket;
filling the food basket with a food product manually by a human or robotically by a robotic system;
positioning the food basket with the food product into the cooking reservoir basin for a period of time;
optionally positioning the food basket above the cooking reservoir basin and vertically shaking the food basket; and
transferring the cooked food product from the cooking reservoir basin to the cooked food products basin via pivoting the robotic arm upon contact with the basket flipping plate.
